(19) United States
(12) Patent Application Publication
(10) Pub. No.: US 2011/0314071 A1
(43) Pub. Date: Dec. 22, 2011

(54) METADATA-BASED DATA ACCESS AND CONTROL

(75) Inventors: Drew S. Johnson, San Carlos, CA (US); Marcelo C. San Martin, Alviso, CA (US); Amit Sinha, Fremont, CA (US); Indranath Ghosh, Santa Clara, CA (US)

(73) Assignee: OPENWAVE SYSTEMS INC., Redwood City, CA (US)

(21) Appl. No.: 12/978,459

(22) Filed: Dec. 24, 2010

Related U.S. Application Data
(60) Provisional application No. 61/356,034, filed on Jun. 17, 2010.

(51) Int. Cl. G06F 17/30

(52) U.S. Cl. 707/827; 707/E17.01

(57) ABSTRACT

Data access is controlled using metadata in the data being stored. As consistent with various example embodiments, data is stored on behalf of one or more of a multitude of disparate users and/or applications using the data, based upon metadata in the data itself and storage rules for the metadata. In one implementation, a rules-based storage and access system retrieves storage rules based upon metadata in received data, and executes the storage rules to select a file system in which to store the received data, from a plurality of file systems having different data retrieval characteristics such as speed, security and quality.

### CROSS-REFERENCE TO RELATED APPLICATION

This application is entitled to the benefit of provisional U.S. Patent Application Ser. No. 61/356,034, filed Jun. 17, 2010, which is incorporated by reference herein.

### FIELD OF THE INVENTION

The present invention relates generally to data access, and more specifically, to metadata-based storage of data for access.

### BACKGROUND OF THE INVENTION

Many storage platforms offer a single set of storage characteristics, such as those relating to access time, availability and cost, where the cost is measured in cost per megabyte and cost per IOPS (I/O Operations per Second).

Many current applications have different storage characteristic needs even within the same application (e.g., email messages versus activity logs), and sometimes even within the same data type. For example, pictures recently added to an album are likely to be accessed on a more regular basis than pictures added at a less recent date (e.g., over a year), where such older pictures may desirably be archived and rarely if ever viewed again.

Currently, client-based applications (referred to herein as client applications) interact with storage systems by providing primitive metadata such as file and folder name, read or write access restrictions, and sometimes an access control list. Many applications such as email and picture albums require storage systems to satisfy fast local access times yet be capable of appearing infinite since users do not delete their content.

With the requirements of infinite storage, the overall cost of owning and/or providing such storage is greatly affected by the cost of the storage. These and other issues remain as a challenge to a variety of methods, devices and systems that use or benefit from data storage.

### SUMMARY

Various aspects of the present invention are directed to devices, methods and systems that address challenges including those discussed above.

According to an example embodiment, a rules-based storage and access system controls the selective storage of data in a plurality of file systems, where different ones of the file systems are deployed on different types of file systems that have different characteristics, such as different input and output capacities. The rules-based storage and access system includes a mobile device interface and an application interface. The interfaces interface with a multitude of disparate mobile devices and applications, such as mobile devices operated by different users over a wireless telephone network and applications that provide services to the users. The rules-based storage and access system is configured, for each of a multitude of users, to receive data from a remote source, retrieve metadata-based data storage rules based upon metadata in the received data, and execute storage instructions in the retrieved data storage rules to select one of the plurality of file systems in which to store the data. The rules-based storage and access system then communicates with the selected file systems to store the received data therein. Once stored, the rules-based storage and access system is responsive to requests for stored data (from an application and/or one of the mobile devices) as received via one of the interfaces, to direct the retrieval of data stored in accordance with the data storage rules for providing the data for communication to an application and/or one of the mobile devices via the corresponding interface.

The above summary is not intended to describe each embodiment or every implementation of the present disclosure. The figures and detailed description that follow more particularly exemplify various embodiments.

### BRIEF DESCRIPTION OF THE DRAWINGS

FIG. 1 depicts a system for controlling data storage and access includes a mobile device interface, a client application interface, and a rules-based storage and access system.

FIG. 2 illustrates a system for storing content, according to another example embodiment of the present invention.

FIG. 3 illustrates a system for storing and retrieving content, according to another example embodiment of the present invention.

FIG. 4 illustrates a system for storing and providing content to mobile devices via a wireless communications system, according to another example embodiment of the present invention.

FIG. 5 illustrates a data storage controller circuit, according to an example embodiment of the present invention.

FIG. 6 depicts a method for controlling the selective storage of data in a plurality of file systems, different ones of the file systems having different data retrieval characteristics.

FIG. 7 depicts a computer that includes a processor, memory, and a communications interface.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims.

### DETAILED DESCRIPTION

An embodiment of the present invention relates to data access systems and approaches as described herein. While the present invention is not necessarily limited to such systems and approaches, various aspects of the invention may be appreciated through a discussion of examples using these and other contexts.

In connection with various example embodiments, a data storage and access system is configured to interface with remote devices, such as mobile telephones and other hand-held devices, to provide multiple types of storage and retrieval functions, each type having characteristics such as cost and speed that are different than the other types, and which may change over time. This storage and access system may operate using a single interface or link to users providing data to store, yet functions at multiple levels based upon the different supported types of storage and retrieval functions (e.g., high-speed systems, low-speed systems). In some applications, the type of storage and retrieval functions (and related systems) used for a particular set of data is selected based upon criteria relating to the data and/or a user of the data, such as by identifying a least-cost storage option that meets performance criteria assigned to the data being stored.

According to a more particular example embodiment, a data storage system controls the selective storage of data in a plurality of file systems, where different ones of the file systems have different data retrieval characteristics (e.g., where each file system includes one or more databases). These storage/retrieval characteristics relate to various aspects of data storage and retrieval, such as the speed of access, number of accesses, reliability, size of data files to be individually retrieved, and others. Different types of storage may thus be tailored to characteristics related to different types of data access. Data is stored and subsequently provided for access by each or a multitude of users, such as for subscribers to a mobile telephony carrier service.

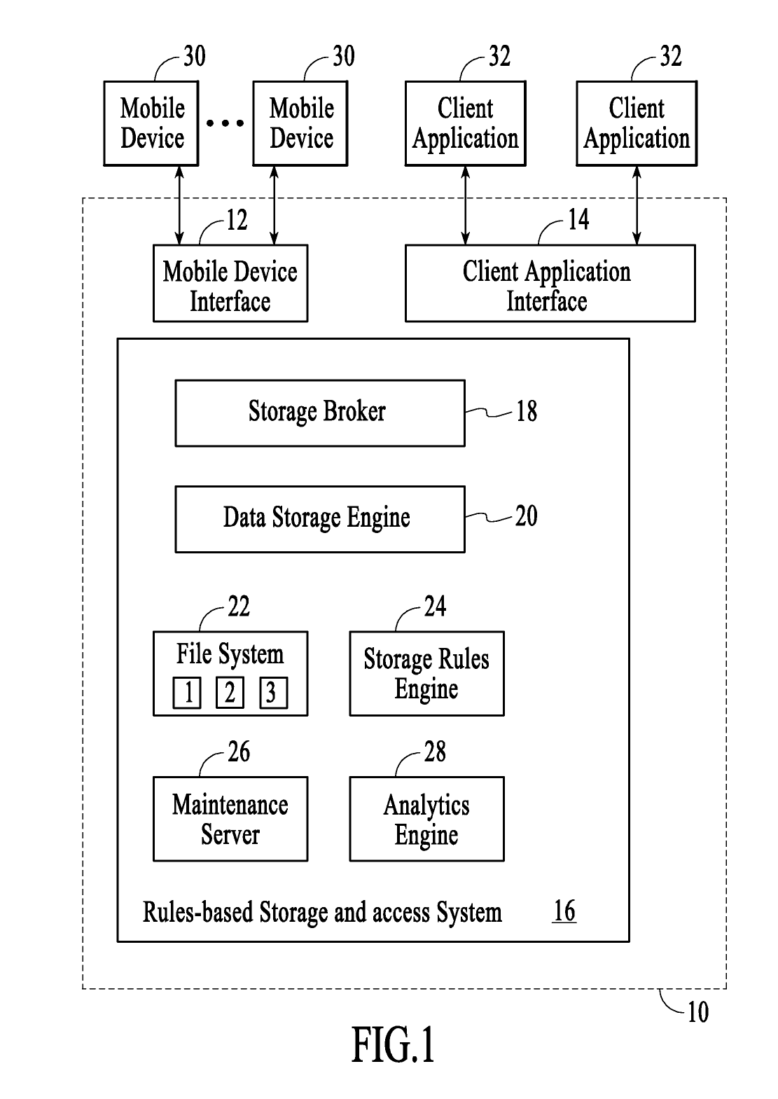

With reference to FIG. 1, a system 10 for controlling data storage and access includes a mobile device interface 12, a client application interface 14, and a rules-based storage and access system (RBSAAS) 16. The rules-based storage and access system includes a storage broker 18, a data storage engine 20, a file system 22, a storage rules engine 24, a maintenance server 26, and an analytics engine 28. The system interfaces with mobile devices 30 and various applications 32. In the embodiment of FIG. 1, the mobile device interface is configured to interface with a multitude of disparate mobile devices operated by different users over a wireless communications network. Accordingly, the mobile device interface may include one or more of a variety of systems, devices, and/or circuits as may be appropriate, such as those involving a mobile telephony-type base station network and related mobile communications circuits and systems.

The rules-based storage and access system 16 is configured to receive data such as image data, an email message, or video data from a remote source, such as a user's hand-held mobile device, a message services provider, a user's PC, or a subscription-based content service. For each set of received data, the rules-based storage and access system retrieves metadata-based data storage rules based upon metadata in the received data. Using the retrieved data storage rules, the rules-based storage and access system executes storage instructions in the retrieved data storage rules to select one of a plurality of file systems in which to store the data. Once selected, the rules-based storage and access system stores the received data in the selected file system according to the data storage rules.

When a user (through his/her mobile device 30) requests access to the stored data, the mobile device interface 12 processes the request and communicates information based upon the request to the rules-based storage and access system 16. Using the request information, the rules-based storage and access system directs the retrieval of data stored in accordance with the data storage rules for providing the data for communication to the user at his/her mobile device, via the mobile device interface. Accordingly, the speed and other characteristics of the user's remote access are based upon the ability of the rules-based storage and access system to access the data from the file system selected for storing the data, which is further based upon metadata in and/or attributed to the stored data.

In some implementations, the rules-based storage and access system 16 is configured to read metadata assigned to the received data by a client application 32 by identifying the type of client application. For instance, when a client application provides email services, metadata in the received data that identifies the client application is used to further identify the data as email data. The rules-based storage and access system uses the identified type of client application in retrieving metadata-based data storage rules for the type of data provided by the client application. In an embodiment, the client applications are hosted remotely from the rules-based storage and access system. That is, the client applications are hosted on an application server that is connected to the rules-based storage and access system via the Internet.

A variety of metadata-based data storage rules are tailored to particular client applications. For instance, data storage rules may be tailored to email-based applications, in which recent email is maintained in a rapid-access file system, and older email is stored in a file system exhibiting slower access times, such as by archiving older email. Data storage rules may also be tailored to applications serving multiple users, where data used by more than one user is stored based upon the collective use of the data by the users. For example, more frequently accessed data is stored in a rapid-access file system and less frequently accessed data is stored in a relatively slower-access file system.

In other implementations, the rules-based storage and access system 16 is configured to execute the storage instructions using dynamic read/write characteristics assigned to the received data as an input to select one of the plurality of file systems in which to store data. For example, as discussed above, recent email may be assigned a high read/write rate due to expected access to the email for viewing, responding to, and/or forwarding. As the email ages, the expected access is assigned a lower read/write rate based upon an expected consideration that the email is less likely to be accessed, if at all. The rules-based storage and access system thus stores the data based upon a corresponding read/write characteristic of the selected file system.

In still other implementations, the rules-based storage and access system 16 is configured to identify different sets of related data based upon metadata in the received data. For instance, related emails in a chain of emails may be linked, or audio data may be linked to a playlist. The rules-based storage and access system uses the identified relationship in executing the storage instructions to select one of the plurality of file systems in which to store the different sets of related data, or to select file systems that are physically close to one another in which to store the related data (e.g., so a bulk-fetch operation can retrieve the data faster). For example, where two different sets of data that are related to one another have different access priority levels (e.g., for different speeds), storage instructions may specify that the related data sets both be stored in the file system having a higher access priority level. Similarly, a set of data may be shared by a variety of client applications or users, and may have replicated versions of the data stored in multiple places; updates to the data can be tracked and used to update other versions of the data stored in different locations.

Another example embodiment is directed to data storage and access in accordance with metadata and user-specific storage and retrieval rules, to control the storage of data in different data storage arrangements according to expected use and/or user-specific storage requirements, as relative to the respective capabilities and other characteristics of the data storage arrangements (e.g., to store data needing fast/recurring access in those file systems that provide such access). With regard to FIG. 1, the storage rules engine 24 stores, in association with identity data for each of a multitude of users, data storage rules that define storage instructions for storing data based upon metadata-based information included with the data. These data storage rules may, for example, define a class of service for particular users, such that users can subscribe to different classes of service for storing data. These classes of service may be correlated with fees assessed for the storage, such that file systems that provide rapid and accurate access to data may be provided at a higher fee than file systems that provide relatively slower access. The access service may relate, for example, to capabilities of various file systems, or to the control of such systems, and related priority assigned to data associated with different classes of service (e.g., data afforded a higher class of service may be stored in the same file system as data afforded a lower class of service, with the higher-class data having priority access over lower-class data with such access controlled by a system that bases such priority upon metadata in the data as associated with and/or identifying a particular class of service).

The mobile device interface 12 interfaces with a multitude of disparate mobile devices operated by different users over a wireless communications network, for routing wireless communications and data to and from the mobile devices 30. The rules-based storage and access system 16 is configured, for each of a multitude of users, to receive data from a remote data source for storing on behalf of the user, and for the received data, to use identity data of the user to retrieve data storage rules associated with the identity data. The rules-based storage and access system then executes storage instructions in the retrieved data storage rules, using metadata in the received data as an input, to select a file system in which to store the data. This selection may, for example, be based upon a class of data storage as discussed above. The rules-based storage and access system communicates with the selected file system to store the received data therein.

For retrieving stored data, the rules-based storage and access system 16 responds to requests for stored data from the mobile devices 30 (as received via the mobile device interface) by retrieving data stored in accordance with the data storage rules for the particular mobile device. For example, a particular user's identification may be associated with a particular mobile device, and the mobile device's identification (as received with communications from the mobile device) may be linked to the user's identification, and accordingly linked to data storage rules to use for the particular mobile device. Such data storage rules may further specify data retrieval instructions that are based upon the capabilities of the mobile device itself and/or a service to which the mobile device subscribes for communications, as may pertain to speed of access, versions of data that is stored and other storage characteristics. The rules-based storage and access system then provides the data for communication to the one of the mobile devices via the mobile device interface 12.

In connection with these and other embodiments, the rules-based storage and access system 16 operates to provide data to and communicate with (as appropriate) the mobile devices 30 over a variety of types of communications links. For example, cellular communication schemes, such as Global System for Mobile communications (GSM), Universal Mobile Telecommunications System (UMTS), and Code Division Multiple Access (CDMA) may be used. In addition, communications protocols such as defined by the 3^{rd} Generation Partnership Project (3GPP) or the 3^{rd} Generation Partnership Project 2 (3GPP2), 4G Long Term Evolution (LTE), for “xG” (further generations), and IEEE 802.16 standards bodies may also be used.

In some implementations, the mobile device interface 12 provides a data storage interface for access by each of the multitude of users, presents data storage and retrieval options to each user, and, in response to receiving data storage or retrieval option selections from a user, stores, in the storage rules engine 24, data storage rules in association with identity data for the user. For example, where a multitude of different types of file systems are available, each with their respective capabilities, the mobile device interface provides information to the users, via the rules-based storage and access system 16. In response to a user input presented at the mobile device 30, such as by a pointer/keyboard type of device or a touch screen, and communicated through a wireless communication network, the mobile device interface stores and/or alters data storage rules for the user providing the input.

The mobile device interface 12 provides a data storage interface to mobile device 30 via one or more types of communications approaches, such as web-based communications via a mobile device network, cellular-type communications, 3G (or related) communications systems, or one or more others are respectively capable of communicating with mobile devices. The presentation of the data storage interface can be tailored to available communications links or other characteristics of communications with mobile devices, or may further interact with inputs received from applications running on mobile devices (e.g., such that the interface is presented using an onboard application at the mobile device).

In some embodiments, the rules-based storage and access system 16 tags received data with metadata based upon rules for a user, and controls the storage of the received data based upon the metadata tag. For instance, when a new set of data such as messaging data or media content is received from a particular user, the rules-based storage and access system identifies the source of the data to identify the user. The rules-based storage and access system then tags the received data based upon the user identification. In one instance, the rules-based storage and access system tags the data with an identifier for the user, which can subsequently be used in looking up data storage and retrieval rules for the identified user. In another instance, the rules-based storage and access system retrieves metadata tag information based upon the user's identification, and tags the received data with the retrieved metadata tag information (e.g., to classify the received data into a particular category assigned to the user).

Referring again to FIG. 1, the rules-based storage and access system 16 controls the storage of data for a multitude of users, in two or more file systems. The rules-based storage and access system communicates with the mobile devices 30 such as a mobile phone or tablet computer, and interfaces with data sources such as client applications 32, e.g., an email client and website clients that store and provide media content. Each of the mobile devices, email clients, and website clients use the rules-based storage and access system to store data in the file systems 22 based upon expected access characteristics of the data and/or levels of data storage service attributed to the data. These examples are only a few of a multitude of mobile device types and data sources that the rules-based storage and access system may communicate with.

In an embodiment, the file system 22 includes a plurality of separate file systems, with three file systems shown by way of example. The file system may, for example, include data storage circuits as well as one or more processors that control the storage of data in the data storage circuits. Although the three file systems are depicted as within a single file system, it should be understood that the file systems can be distributed amongst storage devices that are both local and remote. For example, one file system may be located on a local server for fast access and another of the file systems may be located at an Internet-connected remote server for archived storage (e.g., with relatively slower access times). In another embodiment, one file system may be a RAM based system and another file system is a magnetic disk drive based storage system, both of which may be located on the same server device.

In an embodiment, the storage rules engine 24 provides data storage rules for execution in storing data received on behalf of a multitude of disparate users. The storage rules engine may include a metadata service (not shown) that operates to provide metadata information for use in identifying and storing different types of data.

The rules-based storage and access system 16 is configured to store data in different manners for various applications, which may include one or more of those as discussed above, based upon control inputs and information in data received to be stored, and further generated messaging type communications for communicating with external controllers. Example applications that may utilize storage and access services include email, album (photo), POSIX (Portable Operating System Interface) file, calendar, wave-type collaboration applications and webdav (Web-based Distributed Authoring and Versioning) services. In many implementations, the rules-based storage and access system controls data storage for these applications based upon use of the data, by specific applications or by users.

As an example of personal-use type data storage control, email services may be hosted via the storage and retrieval of email messages, based upon metadata such as that identifying the data as email data and indicating one or more relevant dates upon which future access to the email data may be estimated. One such application involves storing recently-created and/or recently-accessed email data in a file system that provides rapid access to the email data, and correspondingly storing older or seldom-accessed email data in a file system that provides relatively slower access to data. The storage rules engine 24 is configured to retrieve and implement rules for storing email data, such as by executing an algorithm with email metadata as an input to determine which file system, ranging from a relatively faster-access file system to a relatively slower-access file system, in which to store data within. The rules-based storage and access system 16 may also be configured to determine a storage format of data, based upon an expected access (e.g., to archive/compress data that is not expected to be accessed often). In connection with these embodiments, the rules-based storage and access system is configured to respond to relevant dates to select from a file system in which to store data. The rules-based storage and access system is, in certain embodiments, also configured to select from a data format in which to store data, in some instances, for use in storing photo image data.

As another example of personal use-type data storage control, photo album-based data may be similarly managed, with photo image data stored in different file systems based upon the creation and last-access dates attributed to the photo image data, such as indicated in metadata associated with the photo-image data. In one instance, recently-created photos are stored in a fast-access file system and/or in a fast-access format, with photos with older creation dates stored in a slower-access file system and/or slow-access format (e.g., compressed or archived). Photo image data with an older creation date may also be upgraded to a faster-access file system (and a fast-access format, if appropriate) based upon access behavior, such as by monitoring access to the photo image data directly or via metadata in the photo image data. Photo image data with an older creation date may further be upgraded to a faster-access file system (and a fast-access format, if appropriate) based on data linking the photo image data with other image data, such as by linking individual images in a photo album, with the rules-based storage and access system automatically upgrading linked photo image data based upon access characteristics for other linked image data (e.g., the rules-based storage and access system may be programmed to predict data access to all images in a particular photo album in response to access to one of the images in the album, and correspondingly upgrade all linked images to a faster-access file system based upon an access date of a most-recently accessed image). For example, in one embodiment, the accessing of a first data element (e.g., an electronic photo) triggers the immediate movement of linked data elements to a faster-access file system in anticipation of an access request for the linked data elements. In connection with these embodiments, the rules-based storage and access system is configured to respond to photo image data creation and/or access dates to select from a file system, and from a data format in some instances, for use in storing photo image data.

As an example of application-use type data, one or more of a variety of client applications 32, such as calendar applications, operating system interface applications, and distributed/collaboration applications as identified above, store and access data using the rules-based storage and access system 16 to provide services for use at mobile devices. Such applications interact with the rules-based storage and access system for storing and retrieving data, and the rules-based storage and access system stores the data using metadata defined by the applications (e.g., access priority information, such as high, medium, and low access priority) and/or other metadata such as that related to creation of and/or last access times for stored data as discussed above. In some implementations, the applications store and access stored data directly from the rules-based storage and access system, and in other implementations, mobile devices working with the applications store and access stored data from the rules-based storage and access system. In this regard, the rules-based storage and access system stores data for applications in a variety of manners, and can store different types of data for a single application using different storage approaches as appropriate (e.g., data that is used infrequently by an application or that has low importance for operation of the application can be stored in a low-priority file system).

In some embodiments, the rules-based storage and access system 16 is responsive to inputs from mobile device provider systems, such as those pertaining to mobile device analytics data that is used to characterize data storage needs, and uses the analytics-based data storage needs together with metadata in the stored data as inputs for determining an appropriate manner in which to store data. In this context, the rules-based storage and access system may be implemented within a mobile carrier system that provides services to a multitude of mobile devices, or may be implemented as a web-based type of system that is accessed by one or more client applications such as described here.

The rules-based storage and access system 16 is selectively configurable to provide various services, such as locking, versioning, access control, tagging, search, and notification services, in connection with various implementations. For example, the rules-based storage and access system may notify a particular user when the rules-based storage and access system moves stored data from a high-priority storage to a low-priority storage, may actively tag data for storage, or may search for data pertaining to a particular data type (e.g., by searching metadata to identify related data) for modifying storage conditions. The rules-based storage and access system may lock or limit access control to the data, such as for retrieving or modifying data, and can also execute versioning functions to ensure that an appropriate version of data is available (e.g., where data is updated and stored at different storage locations, the rules-based storage and access system may track updates and make related updates in other storage locations, or may store different versions of the data based upon different formats of the data as may be required by different applications or users). Where a particular user specifies that data be searchable, the rules-based storage and access system stores the data in a manner that facilitates such searches, such as by storing searchable data in a data storage format and/or location that is amenable to searching.

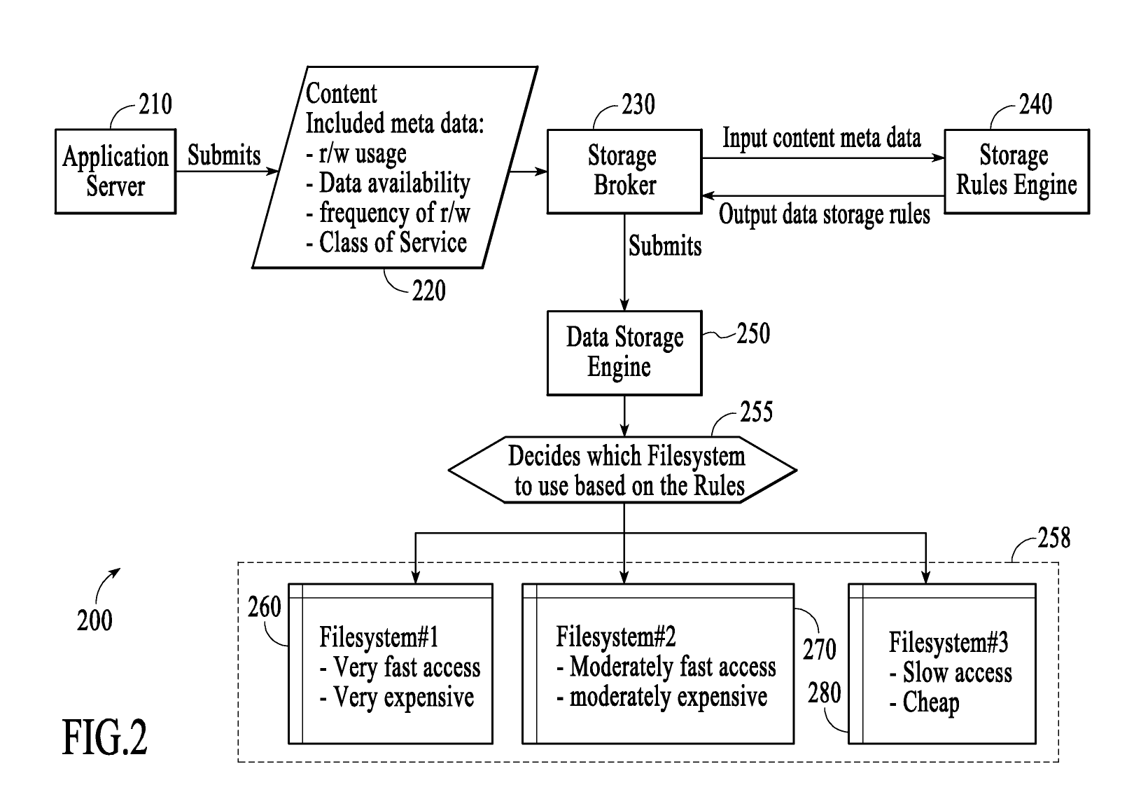

FIG. 2 illustrates a system 200 for storing content for a client application, according to another example embodiment of the present invention. The system includes an application server 210, a storage broker 230, a data storage engine 250, a storage rules engine 240, and a file system 258 that includes three distinct file systems 260, 270, and 280, all of are similar to the corresponding elements described above with reference to FIG. 1. A client application operating on the application server 210 (e.g., operating on a computer circuit) submits content 220 including various data as used by the client application to provide services to a mobile device. By way of example, the data 220 is shown including metadata identifying characteristics of the content such as whether access to the content is read-only or read/write, desired availability of the data, frequency of read and/or write access to the data, and a class of service. These characteristics may be implemented as described above, such as with a class of service defined for data based upon a user's or client application's subscription level, with higher classes of service (e.g., better read/write speeds, higher quality) being assessed higher fees.

The storage broker 230 receives the incoming content 220 and accesses the storage rules engine 240 to retrieve data storage rules that correspond to metadata in the content 220. The storage broker 230 submits the content 220 with retrieved the data storage rules to the data storage engine 250, which decides (at 255) which of a plurality of file systems to use based upon the data storage rules. By way of example, file systems 260, 270 and 280 are shown, respectively having fast, moderate, and slow classes of service applicable to fast, moderate, and slow access. The data storage engine 250 selects one of the file systems based upon the data storage rules, which are in turn based upon the metadata, thus permitting tailored data storage to suit various needs such as those discussed herein.

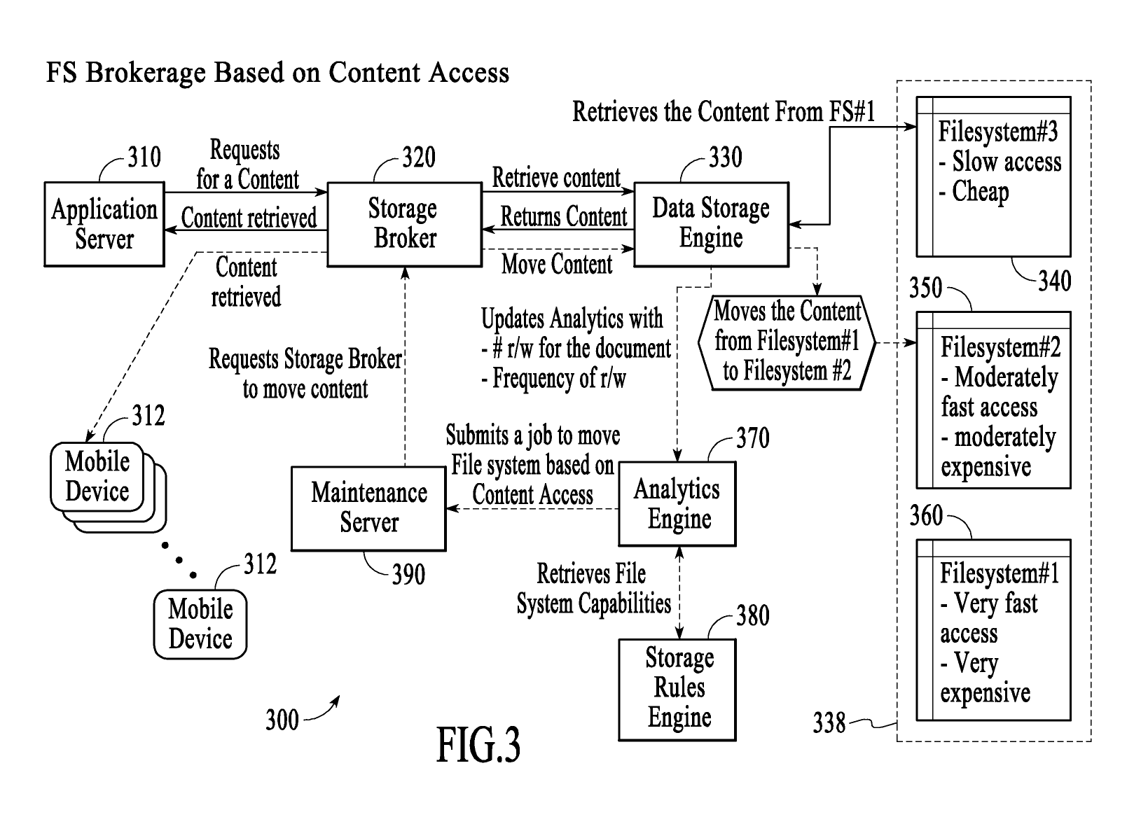

FIG. 3 illustrates a system 300 for storing and accessing content, according to another example embodiment of the present invention. The system includes the application server 310, a storage broker 320, a data storage engine 330, a storage rules engine 380, and a file system 338, as well as an analytics engine 370 and a maintenance server 390, all of which are similar to the corresponding elements described above with reference to FIGS. 1 and 2. The system 300 may, for example, be used for retrieving and/or modifying the storage of content stored in accordance with one or more approaches such as shown in and described above in connection with FIG. 2. A client application 32 operating on application server 310, such as an email application, a media services application, or a remote device application, sends requests for stored content to the storage broker 320. The storage broker 320 responds by sending a request for retrieving the content to the data storage engine 330, which interfaces with a plurality of file systems including file systems 340, 350 and 360. By way of example, file systems 340, 350 and 360 respectively represent systems exhibiting relatively slow, moderate, and relatively fast access speeds. The data storage engine is responsive to content requests received from the storage broker 320 by retrieving the requested content from one of the plurality of file systems and providing the retrieved content to the storage broker 320. In turn, the storage broker 320 provides the requested data back to the application server 310 and/or, in some implementations, to one of a plurality of mobile devices 312. In another embodiment, the content request originates from a mobile device and the corresponding content is provided to the mobile device.

The system 300 manages the storage of data in the respective file systems based upon one or more of a variety of conditions, such as those pertaining to expected or actual use of the stored data, and to classes of service to which users of the stored data subscribe. The analytics engine 370 interfaces with the storage rules engine 380, using active characteristics of stored data as provided by the data storage engine 330 (e.g., read/write access frequency), to determine an appropriate type of file system in which to store data, based upon rules in the storage rules engine 380 and metadata-based characteristics of the stored data. The storage rules engine 380 includes data identifying capabilities of various file systems including systems 340, 350 and 360, such as those pertaining to speed of access as described above, or other capabilities such as those relating to one or more of reliability, redundancy, and security (e.g., with highly-sensitive data stored under higher security or with encryption, which may slow data access speed).

If the analytics engine 370 determines that a particular data set should be moved or otherwise stored differently, the analytics engine submits a file move instruction to a maintenance server 390, which communicates with the storage broker 320 to instruct the storage broker to move the particular data set. In response, the storage broker 320 issues a move content instruction to the data storage engine 330, the instruction specifying a particular set of stored content and a new file system in which to store the content. The data storage engine 330 responds by generating an instruction 335 that effects moving the particular set of stored content (by way of example, shown as moving from file system 360 to file system 350, such as to move data that is infrequently accessed to a slower and less expensive data file system).

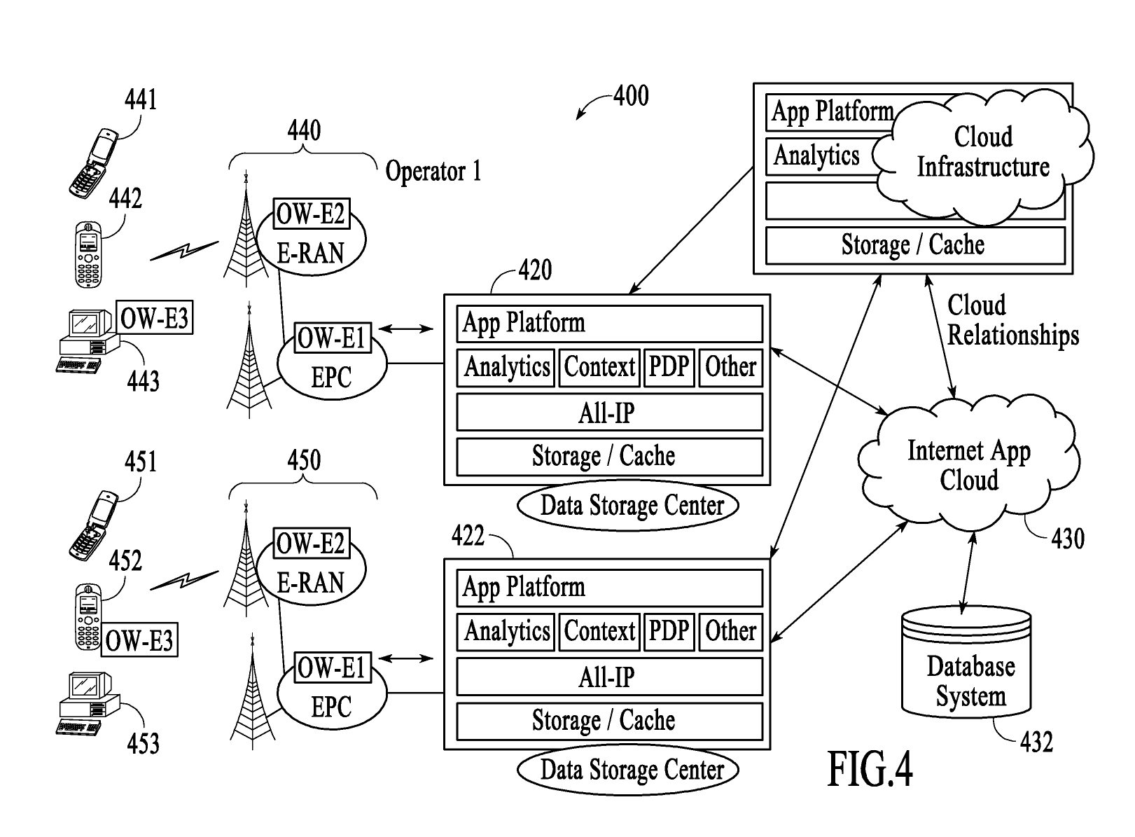

FIG. 4 illustrates a system 400 for storing and providing content to mobile devices via a wireless communications system, according to another example embodiment of the present invention. The system includes platform 410 that interacts with remote users/platforms (e.g., via the Internet at 430), and platforms 420 and 422 that respectively interact with or are part of wireless communications systems 440 and 450 (e.g., including mobile switches, base stations, radio towers and other devices/systems as appropriate). Each of the wireless communications systems interfaces with a multitude of mobile devices, including mobile telephones and mobile computers 441-443 and 451-453 (e.g., laptop or pad computers) shown by way of example. Other file systems, such as system 432, may also be used for storing data for the respective mobile devices, and accessed via platforms 420 and 422. The system 400 may, for example, be implemented in connection with one or more approaches as described above, such as those shown in and described in connection with FIGS. 1-3, with applications operating on and data stored at/via one or more of the Internet 430, platforms 410, 420 and 422, or at the exemplary mobile devices.

By way of example, each of the application platforms is shown having its own respective analytics, storage/cache and other circuits, and platforms 420 and 422 are shown having respective data storage centers as well. These functions may be implemented in connection with the above examples, for storing and accessing data for a multitude of mobile devices. In addition, the respective platforms may serve other platforms (or one another) by storing and providing data in accordance with metadata-based rules and characteristics of the specific application for which data is stored. One aspect of providing fast data access may involve, for example, storing data on an end-user side of a gateway at the platforms 420 and 422, to eliminate the need for passing requested data through a gateway and eliminating related protocol transformation (e.g., from Internet protocols to protocols supported by mobile (wireless) device networks). For example, in an embodiment, data is cached within the network of the wireless communications network service provider in a protocol that is supported by mobile devices. In this way, data can be provided to a mobile device without the data having to pass into the Internet and undergo the associated Internet protocol transformation. In an embodiment, data is cached at the evolved NodeB, GGSN, or SGSN so that the cached data can be providing to a mobile device without having to undergo the protocol transformations that are required to pass data through a gateway such as an Internet gateway. These platforms may thus operate using cloud infrastructure, where a particular user or application may be served (e.g., media content) using one or more aspects of a variety of different content sources and content storage systems. In an embodiment, the platforms include a processor and memory and processor-executable instructions stored thereon to implement the functionality described herein.

Using mobile device 441 in one example, when the mobile device is communicating via the wireless communications system 440 (e.g., a user's mobile telephone is within range of a tower in system 440), data that the mobile device wants to access rapidly can be stored at platform 420, and data requiring less frequent access may be maintained at platform 410 or at another Internet-based data storage location such as at database 432. Depending upon mobile device 441′s use of data, the analytics circuit at the platform 420 (or elsewhere) may direct the movement of data between different data storage locations.

In one embodiment, the system 400 stores data using location-based analytical information available for one or more mobile devices to which content is provided. Using mobile device 441 as an example again, as the device moves out of range of the wireless communications system 440 and into range of the wireless communications system 450 (or between towers within the system 440), data requiring rapid access and stored relatively locally at platform 420 (or even closer to towers serving the device) is moved to match the location of the mobile device. For instance, data stored in a storage/cache of platform 420 can be moved to a storage/cache of platform 422 as the device 441 moves out of range of the mobile device communications system 440 and into the range of the system 450. Less-frequently used data can be maintained at remote systems that are further away from the device 441. In this context, the storage location of data can be managed not only based upon the frequency of the use of the data but the location of one or more devices using the data.

In another example embodiment, the storage of media content that is accessed by two or more mobile devices is collectively managed based upon characteristics associated with both devices (e.g., with respective users of the mobile devices). For instance, where two users subscribe to a particular video, and where one user subscribes to a level of video service that is higher than the level of video service subscribed to by the other user, the subscribed-to video may be stored in a single data storage location to meet the higher subscription level. Accordingly, the user subscribing to a lower level of service (e.g., slower speed) may benefit from such storage. In certain implementations, data delivery systems (e.g., 300 in FIG. 3) intentionally delay the delivery of such content to users subscribing to lower levels of service, where the content is stored in a higher-level file system, in order to mimic the delivery of the content from file systems to which the user is rightfully subscribed, to mitigate the tendency of such users to subscribe to lower levels of service yet benefit from higher service levels subscribed to by other subscribers.

In connection with one or more example embodiments, a client application 32 providing data specifies metadata for the data, which is used to select and implement data storage as discussed above. The metadata may, for example, be specified to set storage characteristics such as those pertaining to one or more of read versus write usage patterns, class of service, anticipated frequency of reads and/or writes, needs for data updates (e.g., for data susceptible to becoming out-of-date), and availability of the data.

According to an example embodiment, a data storage and access system controls the selective storage of data in a plurality of file systems, where different ones of the file systems are deployed on different types of disks that have different characteristics, such as different input and output capacities. The data storage and access system includes an interface circuit and a control circuit. The interface circuit interfaces with a multitude of disparate mobile devices and/or applications, such as devices operated by different users over a wireless telephone network or applications that provide services to the users. The control circuit is configured, for each of a multitude of users, to receive data from a remote source, retrieve metadata-based data storage rules based upon metadata in the received data, and execute storage instructions in the retrieved data storage rules to select one of the plurality of file systems in which to store the data. The control circuit then communicates with the selected file systems to store the received data therein. Once stored, the control circuit is responsive to requests for stored data (from an application and/or one of the mobile devices) as received via the interface circuit, to direct the retrieval of data stored in accordance with the data storage rules for providing the data for communication to an application and/or one of the mobile devices via the interface circuit. In some contexts, the interface circuit includes more than one interface, such as for interfacing with mobile devices (e.g., through a mobile telephone network) and for interfacing with remote applications operating on a packet-based network such as the Internet.

Another example embodiment is directed to a data storage and access system including a rules database, a mobile-device interface circuit and a data storage controller circuit. The rules database stores, in association with identity data for each of a multitude of users, data storage rules that define storage instructions for storing data based upon metadata-based information included with the data. The mobile-device interface circuit interfaces with a multitude of disparate mobile devices operated by different users over a wireless telephone network, for routing telephone communications and data to and from the mobile devices. The data storage controller circuit is configured, for each of a multitude of users, to receive data from a remote data source for storing on behalf of the user, and for the received data, use identity data for the user to retrieve data storage rules associated with the identity data. The data storage controller circuit then executes storage instructions in the retrieved data storage rules, using metadata in the received data as an input with the storage instructions, to select a file system in which to store the data and to further communicate with the selected file system to store the received data therein. In response to a request for stored data from one of the mobile devices as received via the mobile-device interface circuit, the data storage controller circuit retrieves data stored in accordance with the data storage rules and provides the retrieved data for communication to the one of the mobile devices via the mobile-device interface circuit.

In connection with another example embodiment, a data storage and access system controls the selective storage of data in a plurality of file systems on behalf of remote client applications, where different ones of the file systems having different data retrieval characteristics. The storage circuit includes interface circuits including a client-application interface circuit and a mobile-device interface circuit. The client-application interface circuit interfaces with a multitude of disparate client applications for storing data on behalf of each client application and for establishing metadata-based storage rules for the client applications. The mobile-device interface circuit provides stored data to mobile devices subscribing to services provided by the client-application. The storage circuit also includes a rules database that stores the established metadata-based storage rules, and a control circuit that stores and provides data for each of a multitude of client applications. The control circuit receives data sets from a source, where the received data sets include different types of data having different access priorities associated with the respective types of data, and for each received data set, uses metadata in the data set to retrieve metadata-based data storage rules from the rules database. The control circuit uses the retrieved data storage rules to select at least one file system in which to store the received data sets and to direct the storage of the data sets in the selected file system(s). The control circuit is further configured to receive requests specifying stored data for delivery to a particular mobile device, and responds to each received request by identifying one or more file systems in which the specified data resides and directing the delivery of the specified data to the particular mobile device via the mobile device interface circuit.

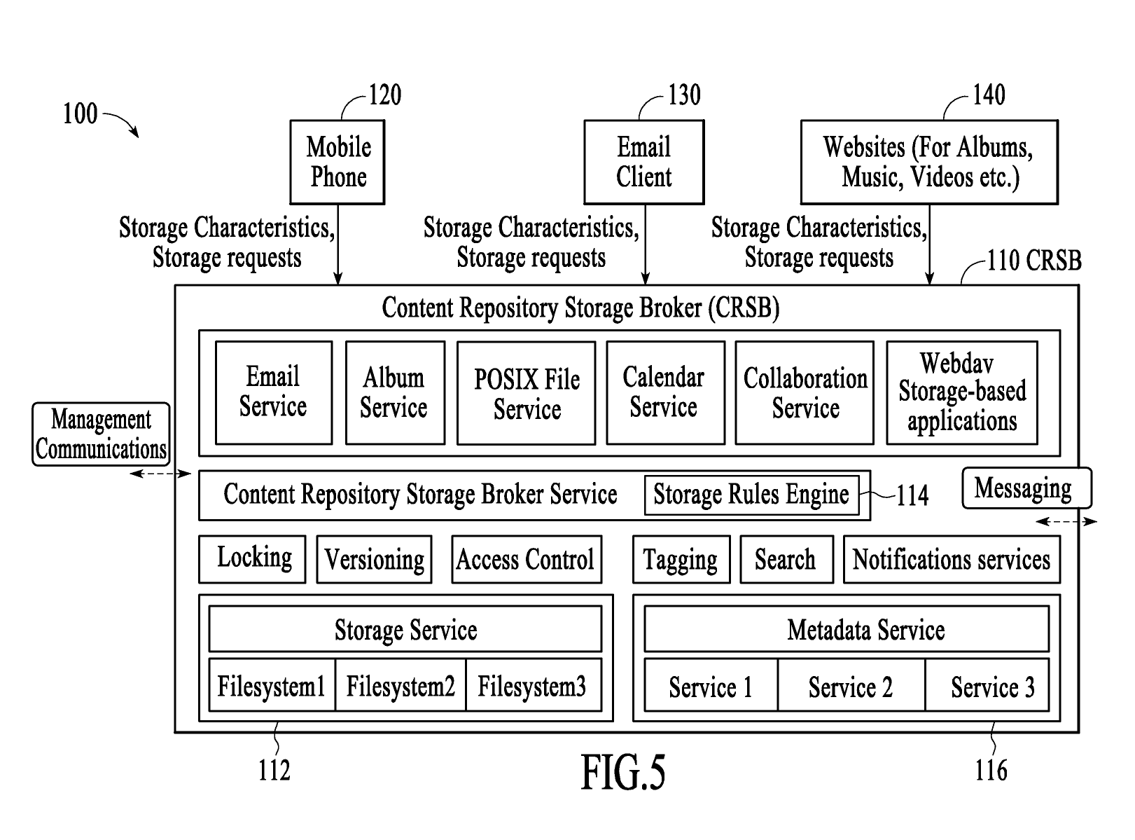

FIG. 5 illustrates a data storage controller circuit 100, according to an example embodiment of the present invention. The circuit 100 includes a content repository storage broker 110 (CRSB), which controls the storage of data for a multitude of users, in two or more file systems. The CRSB 110 communicates with mobile devices such as a mobile phone 120, and interfaces with data sources such as an email client 130 and website clients 140 that store and provide media content. Each of the mobile phone 120, email client 130 and website clients 140 use the CRSB to store data in various file systems based upon expected access characteristics of the data and/or levels of data storage service attributed to the data. These examples are only a few of a multitude of mobile device types and data sources that the CRSB 110 may communicate with.

Internally, the CRSB 110 uses a storage service 112 that includes a plurality of file systems, with three file systems shown by way of example. The storage service may, for example, include data storage circuits as well as one or more processors that control the storage of data in the data storage circuits. The CRSB 110 also includes a storage rules engine 114, which operates as part of the CRSB to provide storage rules for execution in storing data received on behalf of a multitude of disparate users. The CRSB 110 further includes a metadata service 116, with three individual services shown by way of example, which operates to provide metadata information for use in identifying and storing different types of data.

The CRSB 110 is configured to store data in different manners for various applications, which may include one or more of those as discussed above, based upon control inputs and information in data received to be stored, and further generated messaging type communications for communicating with external controllers. Example storage-based applications 111 as shown include email, album (photo), POSIX (Portable Operating System Interface) file, calendar, wave-type collaboration applications and webdav (Web-based Distributed Authoring and Versioning) services. In many implementations, the CRSB 110 controls data storage for these applications based upon use of the data, by specific applications or by users.

As an example of personal-use type data storage control, email services may be hosted via the storage and retrieval of email messages, based upon metadata such as that identifying the data as email data and indicating one or more relevant dates upon which future access to the email data may be estimated. One such application involves storing recently-created and/or recently-accessed email data in a file system that provides rapid access to the email data, and correspondingly storing older or seldom-accessed email data in a file system that provides relatively slower access to data. The storage rules engine 114 is configured to retrieve and implement rules for storing email data, such as by executing an algorithm with email metadata as an input to determine which file system, ranging from relatively faster-access file systems to relatively slower-access file systems, in which to store data within. The CRSB 110 may also be configured to determine a storage format of data, based upon an expected access (e.g., to archive/compress data that is not expected to be accessed often). In connection with these embodiments, the CRSB 110 is configured to respond to relevant dates to select from a file system in which to store data. The CRSB 110 is, in certain embodiments, also configured to select from a data format in which to store data, in some instances, for use in storing photo image data.

As another example of personal use-type data storage control, photo album-based data may be similarly managed, with photo image data stored in different file systems based upon the creation and last-access dates attributed to the photo image data, such as indicated in metadata associated with the photo-image data. In one instance, recently-created photos are stored in a fast-access file system and/or in a fast-access format, with photos with older creation dates stored in a slower-access file system and/or slow-access format (e.g., compressed or archived). Photo image data with an older creation date may also be upgraded to a faster-access file system (and a fast-access format, if appropriate) based upon access behavior, such as by monitoring access to the photo image data directly or via metadata in the photo image data. Photo image data with an older creation date may further be upgraded to a faster-access file system (and a fast-access format, if appropriate) based on data linking the photo image data with other image data, such as by linking individual images in a photo album, with the CRSB 110 automatically upgrading linked photo image data based upon access characteristics for other linked image data (e.g., the CRSB 110 may be programmed to predict data access to all images in a particular photo album in response to access to one of the images in the album, and correspondingly upgrade all linked images to a faster-access file system based upon an access date of a most-recently accessed image). In connection with these embodiments, the CRSB 110 is configured to respond to photo image data creation and/or access dates to select from a file system, and from a data format in some instances, for use in storing photo image data.

As an example of application-use type data, one or more of a variety of applications, such as calendar applications, operating system interface applications and distributed/collaboration applications as identified above, store and access data using the CRSB 110 to provide services for use at mobile hand-held devices. Such applications interact with the CRSB 110 for storing and retrieving data, and the CRSB 110 stores the data using metadata defined by the applications and/or other metadata such as that related to creation of and/or last access times for stored data as discussed above. In some implementations, the applications store and access stored data directly from the CRSB 110, and in other implementations, mobile devices working with the applications store and access stored data from the CRSB 110. In this regard, the CRSB 110 stores data for applications in a variety of manners, and can store different types of data for a single application using different storage approaches as appropriate (e.g., data that is used infrequently by an application or that has low importance for operation of the application can be stored in a low-priority file system).

In some embodiments, the CRSB 110 is responsive to inputs from mobile device provider systems, such as those pertaining to mobile device analytics data that is used to characterize data storage needs, and uses the analytics-based data storage needs together with metadata in the stored data as inputs for determining an appropriate manner in which to store data. In these contexts, the CRSB 110 may be implemented within a mobile carrier system that provides services to a multitude of mobile devices, or may be implemented as a web-based type of system that is accessed by one or more applications such as described here.

The CRSB 110 is selectively configurable to provide various services, in connection with various implementations. Locking, versioning, access control, tagging, search, and notification services are shown by way of example. For example, the CRSB 110 may notify a particular user when the CRSB moves stored data from a high-priority storage to a low-priority storage, may actively tag data for storage, or may search for data pertaining to a particular data type (e.g., by searching metadata to identify related data) for modifying storage conditions. The CRSB 110 may lock or limit access control to the data, such as for retrieving or modifying data, and can also execute versioning functions to ensure that an appropriate version of data is available (e.g., where data is updated and stored at different storage locations, the CRSB 110 may track updates and make related updates in other storage locations, or may store different versions of the data based upon different formats of the data as may be required by different applications or users). Where a particular user specifies that data be searchable, the CRSB 110 stores the data in a manner that facilitates such searches, such as by storing searchable data in a data storage format and/or location that is amenable to searching.

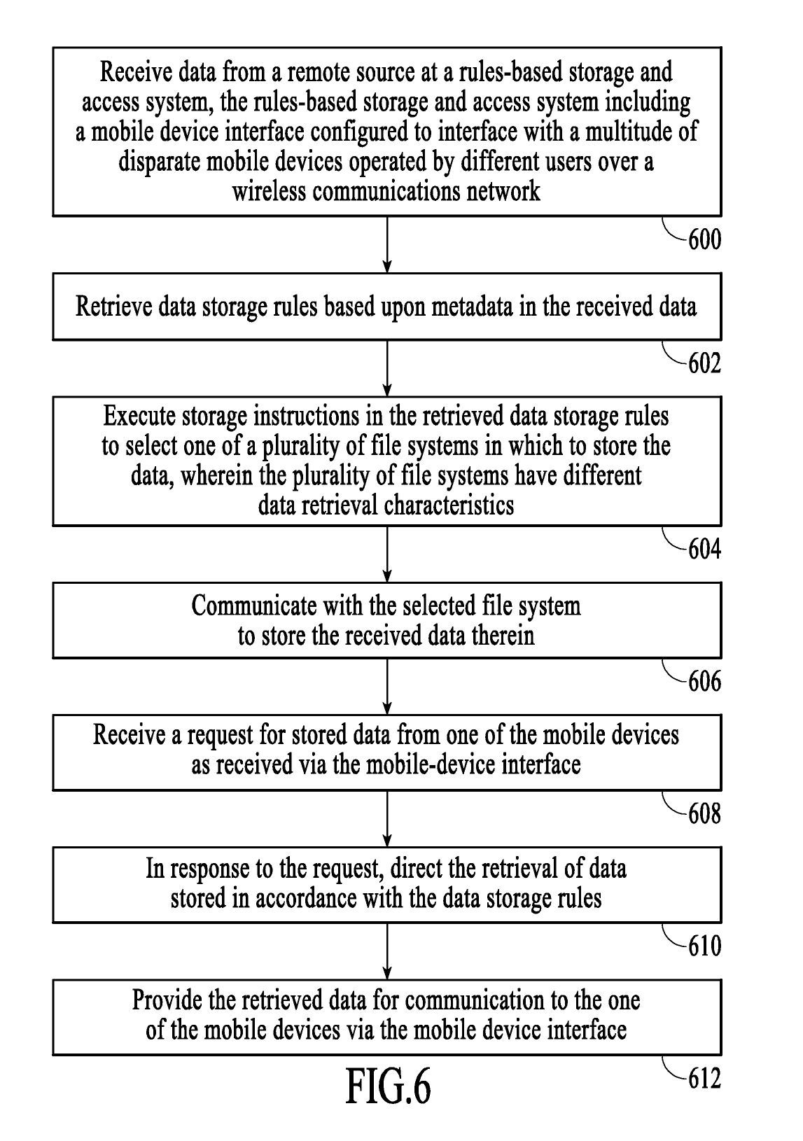

FIG. 6 depicts a method for controlling the selective storage of data in a plurality of file systems, different ones of the file systems having different data retrieval characteristics. At block 600, data is received from a remote source at a rules-based storage and access system, the rules-based storage and access system including a mobile device interface configured to interface with a multitude of disparate mobile devices operated by different users over a wireless communications network. At block 602, data storage rules are retrieved based upon metadata in the received data. At block 604, storage instructions in the retrieved data storage rules are executed to select one of a plurality of file systems in which to store the data, wherein the plurality of file systems have different data retrieval characteristics. At block 606, the selected file system is communicated with to store the received data therein. At block 608, a request for stored data is received from one of the mobile devices as received via the mobile-device interface. At block 610, in response to the request, the retrieval of data stored is directed in accordance with the data storage rules. At block 612, the retrieved data is provided for communication to the one of the mobile devices via the mobile device interface.

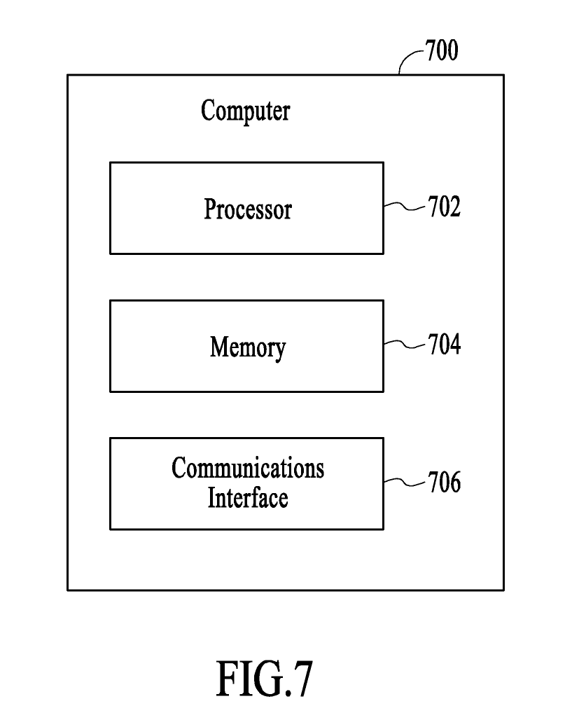

FIG. 7 depicts a computer 700 that includes a processor 702, memory 704, and a communications interface 706. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via communications protocols, for example, via the Internet Protocol (IP). The computer executes computer readable instructions stored in the storage medium to implement various tasks as described above.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Various embodiments described above and shown in the figures may be implemented together and/or in other manners. One or more of the items depicted in the drawings/figures can also be implemented in a more separated or integrated manner, or removed and/or rendered as inoperable in certain cases, as is useful in accordance with particular applications. For example, various embodiments directed to data storage controllers and/or data storage circuits may be implemented with a variety of circuits and/or systems. Embodiments directed to the provision of data to applications may be used to provide data directly to users on mobile or other packet-based devices connected via one or more of a multitude of disparate types of communications networks, with modifications to data and/or the class of storage and retrieval selectively implemented based upon these networks. In addition, various embodiments are directed to the integration of data storage and control into other systems, such as mobile communications systems. Moreover, as relevant for different applications, communications for directing the storage of data and/or providing stored data for use may be made over a variety of networks and using a variety of protocols, such as packet-based networks using the Internet protocol as described herein (e.g., to receive media content), and telephony protocols such as the SS7 protocol, and others (e.g., to deliver content to mobile devices). In view of the description herein, those skilled in the art will recognize that many changes may be made thereto without departing from the spirit and scope of the present invention.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for controlling the selective storage of data in a plurality of file systems, different ones of the file systems having different data retrieval characteristics, the system comprising:
a mobile device interface configured to interface with a multitude of disparate mobile devices operated by different users over a wireless communications network; and
a rules-based storage and access system configured, for each of a multitude of users, to
receive data from a remote source,
retrieve data storage rules based upon metadata in the received data,
execute storage instructions in the retrieved data storage rules to select one of the plurality of file systems in which to store the data,
communicate with the selected file system to store the received data therein, and
in response to a request for stored data from one of the mobile devices as received via the mobile-device interface, direct the retrieval of data stored in accordance with the data storage rules for providing the data for communication to the one of the mobile devices via the mobile device interface.

2. The system of claim 1, wherein the rules-based storage and access system is configured to:
read metadata assigned to the received data by a client application by identifying the type of client application; and
retrieve the metadata-based storage rules based upon the identified type of client application.

3. The system of claim 1, wherein the rules-based storage and access system is configured to execute the storage instructions using a read/write characteristic assigned to the received data as an input to select one of the plurality of file systems in which to store data, based upon a corresponding read/write characteristic of the selected file system.

4. The system of claim 1, wherein the rules-based storage and access system is configured to:
identify different sets of related data based upon metadata in the received data; and
execute the storage instructions using the identification to select one of the plurality of file systems in which to store the different sets of related data.

5. The system of claim 1, wherein the rules-based storage and access system is configured to execute storage instructions in the retrieved data storage rules to select one of the plurality of file systems in which to store the data by using metadata and a content type of the data to determine an expected access rate for the stored data, and by selecting one of the plurality of file systems based upon the determined access rate.

6. The system of claim 1, wherein the rules-based storage and access system further comprises an analytics engine configured to use active data access characteristics for stored data sets to determine an appropriate file system in which the data sets should be stored, and in response to determining that a data set should be stored in a different file system that is different than a file system in which the data set is currently stored, communicate with the file system to direct the movement of the data set from the current file system to the different file system.

7. The system of claim 1, wherein the rules-based storage and access system further comprises an analytics engine configured to track the location of at least one mobile device to which stored data is provided, and to modify the location of stored data based upon the tracked location and information identifying stored data expected to be provided to the at least one mobile device.

8. A system for controlling the selective storage of data in a plurality of file systems, different ones of the file systems having different data retrieval characteristics, the system comprising:
a client application interface configured to interface with a multitude of disparate client applications that provide content services to mobile devices; and
a rules-based storage and access system configured, for each of the client applications, to
receive data from a remote source,
retrieve data storage rules based upon metadata in the received data;
execute storage instructions in the retrieved data storage rules to select one of the plurality of file systems in which to store the data, based upon performance characteristics of the plurality of file systems,
communicate with the selected file system to store the received data therein, and
in response to a request for stored data from one of the client applications, direct the retrieval of data stored in accordance with the data storage rules for providing the data for communication to a mobile device to which the client application provides content services.

9. The system of claim 8, wherein the rules-based storage and access system is further configured to define the metadata-based storage rules for each of the client applications, and to generate and store the defined storage rules for use in storing the received data.

10. A data storage system comprising:
a mobile device interface configured to interface with a multitude of disparate mobile devices operated by different users over a wireless communications network, for routing wireless communications and data to and from the mobile devices; and
a rules-based storage and access system comprising;
a storage rules engine that stores, in association with identity data for each of a multitude of users, data storage rules that define storage instructions for storing data based upon metadata-based information included with the data;
wherein the rules-based storage engine is configured, for each of a multitude of users, to
receive data from a remote data source for storing on behalf of the user,
for received data, use identity data for the user to retrieve data storage rules associated with the identity data,
execute storage instructions in the retrieved data storage rules, using metadata in the received data as an input with the storage instructions, to select a file system in which to store the data,
communicate with the selected file system to store the received data therein, and
in response to a request for stored data from one of the mobile devices as received via the mobile device interface, retrieve data stored in accordance with the data storage rules and provide the data for communication to the one of the mobile devices via the mobile device interface.

11. The system of claim 10, wherein the mobile-device interface is configured to
provide a data storage interface for access by each of the multitude of users,
present data storage and retrieval options to each user, and
in response to receiving data storage or retrieval option selections from a user, storing, in the rules database, data storage rules in association with identity data for the user.

12. The system of claim 10, wherein the rules-based storage engine is configured to tag received data with metadata based upon rules for a user, and to store the received data based upon the metadata tag.

13. The system of claim 10, wherein the rules-based storage engine is configured to monitor access to stored data, and to modify the monitored data's storage location based upon a monitored change in access patterns for the monitored data.

14. The system of claim 10, wherein the rules-based storage engine is configured to monitor the location of mobile devices to which the stored data is provided, and to modify the storage location of the stored data in response to the monitored location of mobile devices using the stored data.

15. A system for controlling the selective storage of data in a plurality of file systems on behalf of client applications, different ones of the file systems having different data retrieval characteristics, the system comprising:
a client application interface configured to interface with a multitude of disparate client applications for storing data on behalf of each client application and for establishing metadata-based storage rules for the client applications;
a mobile-device interface for providing stored data to mobile devices subscribing to services provided by the client applications;
a rules-based storage and access system comprising a storage rules engine that stores the established metadata-based data storage rules;
wherein the rules-based storage engine is configured, for each of a multitude of client applications, to
receive data sets from a source, the received data sets including different types of data having different access priorities associated with the respective types of data,
for each received data set, use metadata in the data set to retrieve metadata-based data storage rules from the rules database;
use the retrieved metadata-based data storage rules to select at least one file system in which to store each of the received data sets,
store each of the received data sets in the file system selected for the data set,
receive requests specifying stored data for delivery to a particular mobile device, and
in response to each received request, identify one or more file systems in which the specified data resides and direct the delivery of the specified data to the particular mobile device via the mobile device interface circuit.

16. The system of claim 15, wherein the rules-based storage engine is configured to receive requests by receiving requests from the application via the application interface.

17. The system of claim 15, wherein the rules-based storage engine is configured to receive requests by receiving requests from a mobile device via the mobile device interface.

18. The system of claim 15, wherein
the application interface is configured to interface with the client applications via a packet-based network, and
the mobile device interface is configured to interface with mobile devices over a wireless communications system.

19. The system of claim 15, wherein:
the mobile device interface is part of a wireless communications system configured to route telephone calls and data to a multitude of mobile devices over a wireless communications network using the mobile device interface; and
the client application interface is configured to interface with client applications via a packet-based network including the Internet.

20. The system of claim 15, further including an application server that operates at least one of the client applications for providing services to mobile devices via the mobile device interface.

21. A method for controlling the selective storage of data in a plurality of file systems, different ones of the file systems having different data retrieval characteristics, the method comprising:
receiving data from a remote source at a rules-based storage and access system, the rules-based storage and access system including a mobile device interface configured to interface with a multitude of disparate mobile devices operated by different users over a wireless communications network;
retrieving data storage rules based upon metadata in the received data;
executing storage instructions in the retrieved data storage rules to select one of a plurality of file systems in which to store the data, wherein the plurality of file systems have different data retrieval characteristics;
communicating with the selected file system to store the received data therein;
receiving a request for stored data from one of the mobile devices as received via the mobile-device interface;
in response to the request, directing the retrieval of data stored in accordance with the data storage rules; and
providing the retrieved data for communication to the one of the mobile devices via the mobile device interface.
